(19) United States
(12) Patent Application Publication
(10) Pub. No.: US 2018/0072615 A1
(43) Pub. Date: Mar. 15, 2018

(54) Glass Article Containing a Composite Coating

(71) Applicant: Guardian Glass, LLC, Auburn Hills, MI (US)

(72) Inventor: Liang Liang, Taylor, MI (US)

(21) Appl. No.: 15/704,081

(22) Filed: Sep. 14, 2017

Related U.S. Application Data
(60) Provisional application No. 62/394,252, filed on Sep. 14, 2016.

(51) Int. Cl. C03C 17/00; C03C 17/04; C03C 17/32; C03C 17/36; B32B 17/10; B32B 15/04; B32B 37/02; B32B 37/06; B32B 7/12

(52) U.S. Cl. CPC C03C 17/008; C03C 17/04; C03C 17/328; C03C 17/3636; B32B 2038/0076; B32B 15/04; B32B 37/02; B32B 37/06; B32B 7/12; B32B 17/10

(57) ABSTRACT

A glass article that comprises a composite coating is provided. The coating is provided on a surface of a glass substrate and comprises a paint layer that overlies the surface of the glass substrate and a hydrophobic layer that overlies the paint layer. The coating may exhibit a ΔE value of about 2 or less after being exposed to a copper-accelerated acetic acid-salt spray (“CASS”) in accordance with ASTM B368-09 (2014).

### CROSS REFERENCE TO RELATED APPLICATIONS

The present application claims filing benefit of U.S. Provisional Patent Application Ser. No. 62/394,252 having a filing date of Sep. 14, 2016, and which is incorporated herein by reference in its entirety.

### BACKGROUND OF THE INVENTION

Decorative glass is becoming more and more popular in residential, commercial, and interior applications. For instance, decorative glass is often formed by a process that involves coating a glass substrate with an organic-based paint layer and then curing the paint layer in an oven. Because many conventional organic-based paints are sensitive to corrosive materials (e.g., acids), however, the color of painted glass articles often changes when exposed to these materials during use and/or testing. As such, a need continues to exist for improved decorative glass articles that are capable of maintaining their color even after exposure to various types of corrosive materials.

### SUMMARY OF THE INVENTION

In accordance with one embodiment of the present invention, a glass article is disclosed that comprises a composite coating provided on a surface of a glass substrate. The composite coating comprises a paint layer that overlies the surface of the glass substrate and a hydrophobic layer that overlies the paint layer. The coating exhibits a ΔE value of about 2 or less after being exposed to a copper-accelerated acetic acid-salt spray (“CASS”) in accordance with ASTM B368-09 (2014).

In accordance with another embodiment of the present invention, a glass article is disclosed that comprises a glass substrate and a composite coating provided on a surface of a glass substrate. The composite coating comprises a paint layer that overlies the surface of the glass substrate and a hydrophobic layer that overlies the paint layer. The paint layer contains a glass frit and a thermoset polymer, and the hydrophobic layer contains an organosilane compound that is bonded to the paint layer.

In accordance with yet another embodiment of the present invention, a method for forming a glass article is disclosed that comprises applying a coating formulation to a surface of a glass substrate, wherein the coating formulation contains a crosslinkable resin and a glass frit; curing the coating formulation to form a paint layer; applying a solution of a hydrophobic material to the paint layer; and curing the hydrophobic material to form a hydrophobic layer that is bonded to the paint layer.

Other features and aspects of the present invention are set forth in greater detail below.

### DETAILED DESCRIPTION OF REPRESENTATIVE EMBODIMENTS

### Definitions

It is to be understood that the terminology used herein is for the purpose of describing particular embodiments only and is not intended to limit the scope of the present invention.

“Alkyl” refers to a monovalent saturated aliphatic hydrocarbyl group, such as those having from 1 to 25 carbon atoms and, in some embodiments, from 1 to 12 carbon atoms. “C_{x-y}alkyl” refers to alkyl groups having from x to y carbon atoms. This term includes, by way of example, linear and branched hydrocarbyl groups such as methyl (CH₃), ethyl (CH₃CH₂), n-propyl (CH₃CH₂CH₂), isopropyl ((CH₃)₂CH), n-butyl (CH₃CH₂CH₂CH₂), isobutyl ((CH₃)₂CHCH₂), sec-butyl ((CH₃)(CH₃CH₂)CH), t-butyl ((CH₃)₃C), n-pentyl (CH₃CH₂CH₂CH₂CH₂), neopentyl ((CH₃)₃CCH₂), hexyl (CH₃(CH₂CH₂CH₂)₅), etc.

“Alkenyl” refers to a linear or branched hydrocarbyl group, such as those having from 2 to 10 carbon atoms, and in some embodiments from 2 to 6 carbon atoms or 2 to 4 carbon atoms, and having at least 1 site of vinyl unsaturation (>C═C<). For example, (Cₓ-C_{y})alkenyl refers to alkenyl groups having from x to y carbon atoms and is meant to include for example, ethenyl, propenyl, 1,3-butadienyl, and so forth.

“Aryl” refers to an aromatic group, which may have from 3 to 14 carbon atoms and no ring heteroatoms and having a single ring (e.g., phenyl) or multiple condensed (fused) rings (e.g., naphthyl or anthryl). For multiple ring systems, including fused, bridged, and spiro ring systems having aromatic and non-aromatic rings that have no ring heteroatoms, the term “Aryl” applies when the point of attachment is at an aromatic carbon atom (e.g., 5,6,7,8 tetrahydronaphthalene-2-yl is an aryl group as its point of attachment is at the 2-position of the aromatic phenyl ring).

“Cycloalkyl” refers to a saturated or partially saturated cyclic group, which may have from 3 to 14 carbon atoms and no ring heteroatoms and having a single ring or multiple rings including fused, bridged, and spiro ring systems. For multiple ring systems having aromatic and non-aromatic rings that have no ring heteroatoms, the term “cycloalkyl” applies when the point of attachment is at a non-aromatic carbon atom (e.g., 5,6,7,8,-tetrahydronaphthalene-5-yl). The term “cycloalkyl” includes cycloalkenyl groups, such as adamantyl, cyclopropyl, cyclobutyl, cyclopentyl, cyclooctyl, and cyclohexenyl. The term “cycloalkenyl” is sometimes employed to refer to a partially saturated cycloalkyl ring having at least one site of >C═C<ring unsaturation.

“Halo” or “halogen” refers to fluoro, chloro, bromo, and iodo.

“Haloalkyl” refers to substitution of an alkyl group with 1 to 5, or in some embodiments, from 1 to 3 halo groups.

“Heteroaryl” refers to an aromatic group, which may have from 1 to 14 carbon atoms and 1 to 6 heteroatoms selected from oxygen, nitrogen, and sulfur and includes single ring (e.g., imidazolyl) and multiple ring systems (e.g., benzimidazol-2-yl and benzimidazol-6-yl). For multiple ring systems, including fused, bridged, and spiro ring systems having aromatic and non-aromatic rings, the term “heteroaryl” applies if there is at least one ring heteroatom and the point of attachment is at an atom of an aromatic ring (e.g., 1,2,3,4-tetrahydroquinolin-6-yl and 5,6,7,8-tetrahydroquinolin-3-yl). In some embodiments, the nitrogen and/or the sulfur ring atom(s) of the heteroaryl group are optionally oxidized to provide for the N oxide (N→O), sulfinyl, or sulfonyl moieties. Examples of heteroaryl groups include, but are not limited to, pyridyl, furanyl, thienyl, thiazolyl, isothiazolyl, triazolyl, imidazolyl, imidazolinyl, isoxazolyl, pyrrolyl, pyrazolyl, pyridazinyl, pyrimidinyl, purinyl, phthalazyl, naphthylpryidyl, benzofuranyl, tetrahydrobenzofuranyl, isobenzofuranyl, benzothiazolyl, benzoisothiazolyl, benzotriazolyl, indolyl, isoindolyl, indolizinyl, dihydroindolyl, indazolyl, indolinyl, benzoxazolyl, quinolyl, isoquinolyl, quinolizyl, quianazolyl, quinoxalyl, tetrahydroquinolinyl, isoquinolyl, quinazolinonyl, benzimidazolyl, benzisoxazolyl, benzothienyl, benzopyridazinyl, pteridinyl, carbazolyl, carbolinyl, phenanthridinyl, acridinyl, phenanthrolinyl, phenazinyl, phenoxazinyl, phenothiazinyl, and phthalim idyl.

“Heterocyclic” or “heterocycle” or “heterocycloalkyl” or “heterocyclyl” refers to a saturated or partially saturated cyclic group, which may have from 1 to 14 carbon atoms and from 1 to 6 heteroatoms selected from nitrogen, sulfur, or oxygen and includes single ring and multiple ring systems including fused, bridged, and spiro ring systems. For multiple ring systems having aromatic and/or non-aromatic rings, the terms “heterocyclic”, “heterocycle”, “heterocycloalkyl”, or “heterocyclyl” apply when there is at least one ring heteroatom and the point of attachment is at an atom of a non-aromatic ring (e.g., decahydroquinolin-6-yl). In some embodiments, the nitrogen and/or sulfur atom(s) of the heterocyclic group are optionally oxidized to provide for the N oxide, sulfinyl, sulfonyl moieties. Examples of heterocyclyl groups include, but are not limited to, azetidinyl, tetrahydropyranyl, piperidinyl, N-methylpiperidin-3-yl, piperazinyl, N-methylpyrrolidin-3-yl, 3-pyrrolidinyl, 2-pyrrolidon-1-yl, morpholinyl, thiomorpholinyl, imidazolidinyl, and pyrrolidinyl.

It should be understood that the aforementioned definitions encompass unsubstituted groups, as well as groups substituted with one or more other groups as is known in the art. For example, an alkyl, alkenyl, alkynyl, aryl, heteroaryl, cycloalkyl, or heterocyclyl group may be substituted with from 1 to 8, in some embodiments from 1 to 5, in some embodiments from 1 to 3, and in some embodiments, from 1 to 2 substituents selected from alkyl, alkenyl, alkynyl, alkoxy, acyl, acylamino, acyloxy, amino, quaternary amino, amide, imino, amidino, aminocarbonylamino, amidinocarbonylamino, am inothiocarbonyl, aminocarbonylamino, aminothiocarbonylamino, aminocarbonyloxy, aminosulfonyl, aminosulfonyloxy, aminosulfonylamino, aryl, aryloxy, arylthio, azido, carboxyl, carboxyl ester, (carboxyl ester)amino, (carboxyl ester)oxy, cyano, cycloalkyl, cycloalkyloxy, cycloalkylthio, epoxy, guanidino, halo, haloalkyl, haloalkoxy, hydroxy, hydroxyamino, alkoxyamino, hydrazino, heteroaryl, heteroaryloxy, heteroarylthio, heterocyclyl, heterocyclyloxy, heterocyclylthio, nitro, oxo, oxy, thione, phosphate, phosphonate, phosphinate, phosphonamidate, phosphorodiamidate, phosphoramidate monoester, cyclic phosphoramidate, cyclic phosphorodiamidate, phosphoramidate diester, sulfate, sulfonate, sulfonyl, substituted sulfonyl, sulfonyloxy, thioacyl, thiocyanate, thiol, alkylthio, etc., as well as combinations of such substituents.

### DETAILED DESCRIPTION

It is to be understood by one of ordinary skill in the art that the present discussion is a description of exemplary embodiments only, and is not intended as limiting the broader aspects of the present invention.

Generally speaking, the present invention is directed to a glass article that contains a glass substrate and a composite coating provided on one or more surfaces of the substrate. The composite coating includes at least one paint layer that overlies the surface of the substrate and a hydrophobic layer that overlies the paint layer. By selectively controlling the particular nature of the paint layer and hydrophobic layer, the present inventor has discovered that the resulting glass article may exhibit a variety of beneficial properties. For example, after being exposed to a copper-accelerated acetic acid-salt spray (“CASS”) in accordance with ASTM B368-09 (2014), the coating may exhibit minimal color change. The color change can be characterized by the ΔE value, which is known in the art and described in more detail below. More particularly, the ΔE value of the coating may be about 2 or less, in some embodiments about 1 or less, and in some embodiments, from about 0.01 to about 0.5. The coating may also be water repellant and thus exhibit an advancing contact angle of about 50° or more, in some embodiments about 60° or more, and in some embodiments, from about 70° to about 90° as determined in accordance with ASTM D7334-08 (2013). Once again, because the coating is generally resistant to corrosive materials, it can also maintain the water contact angle values noted above after being rubbed with methyl ethyl ketone for 100, 200, or 300 cycles in accordance with ASTM D5402-15 and/or after being soaked in either a 2 wt. % hydrogen chloride (HCl) aqueous solution or a 4 wt. % sodium hydroxide (NaOH) aqueous solution for a time period of 30, 60, or even 180 minutes. Furthermore, the coating may be abrasion resistant such that it can also maintain the water contact angle values noted above after being subjected to 300, 600, 1,000, or 1,500 brush cycles in accordance with the test method described below.

Various embodiments of the present invention will now be described in more detail.

### I. Glass Substrate

The glass substrate typically has a thickness of from about 0.1 to about 15 millimeters, in some embodiments from about 0.5 to about 10 millimeters, and in some embodiments, from about 1 to about 8 millimeters. The glass substrate may be formed by any suitable process, such as by a float process, fusion, down-draw, roll-out, etc. Regardless, the substrate is formed from a glass composition having a glass transition temperature that is typically from about 500° C. to about 700° C. The composition, for instance, may contain silica (SiO₂), one or more alkaline earth metal oxides (e.g., magnesium oxide (MgO), calcium oxide (CaO), barium oxide (BaO), and strontium oxide (SrO)), and one or more alkali metal oxides (e.g., sodium oxide (Na₂O), lithium oxide (Li₂O), and potassium oxide (K₂O)).

SiO₂ typically constitutes from about 55 mol. % to about 85 mol. %, in some embodiments from about 60 mol. % to about 80 mol. %, and in some embodiments, from about 65 mol. % to about 75 mol. % of the composition. Alkaline earth metal oxides may likewise constitute from about 5 mol. % to about 25 mol. %, in some embodiments from about 10 mol. % to about 20 mol. %, and in some embodiments, from about 12 mol. % to about 18 mol. % of the composition. In particular embodiments, MgO may constitute from about 0.5 mol. % to about 10 mol. %, in some embodiments from about 1 mol. % to about 8 mol. %, and in some embodiments, from about 3 mol. % to about 6 mol. % of the composition, while CaO may constitute from about 1 mol. % to about 18 mol. %, in some embodiments from about 2 mol. % to about 15 mol. %, and in some embodiments, from about 6 mol. % to about 14 mol. % of the composition. Alkali metal oxides may constitute from about 5 mol. % to about 25 mol. %, in some embodiments from about 10 mol. % to about 20 mol. %, and in some embodiments, from about 12 mol. % to about 18 mol. % of the composition. In particular embodiments, Na₂O may constitute from about 1 mol. % to about 20 mol. %, in some embodiments from about 5 mol. % to about 18 mol. %, and in some embodiments, from about 8 mol. % to about 15 mol. % of the composition. Of course, other components may also be incorporated into the glass composition as is known to those skilled in the art. For instance, in certain embodiments, the composition may contain aluminum oxide (Al₂O₃). Typically, Al₂O₃ is employed in an amount such that the sum of the weight percentage of SiO₂ and Al₂O₃ does not exceed 85 mol. %. For example, Al₂O₃ may be employed in an amount from about 0.01 mol. % to about 3 mol. %, in some embodiments from about 0.02 mol. % to about 2.5 mol. %, and in some embodiments, from about 0.05 mol. % to about 2 mol. % of the composition. In other embodiments, the composition may also contain iron oxide (Fe₂O₃), such as in an amount from about 0.001 mol. % to about 8 mol. %, in some embodiments from about 0.005 mol. % to about 7 mol. %, and in some embodiments, from about 0.01 mol. % to about 6 mol. % of the composition. Still other suitable components that may be included in the composition may include, for instance, titanium dioxide (TiO₂), chromium (III) oxide (Cr₂O₃), zirconium dioxide (ZrO₂), ytrria (Y₂O₃), cesium dioxide (CeO₂), manganese dioxide (MnO₂), cobalt (II, III) oxide (Co₃O₄), metals (e.g., Ni, Cr, V, Se, Au, Ag, Cd, etc.), and so forth.

### II. Composite Coating

As indicated above, a composite coating is provided on one or more surfaces of the substrate. For example, the glass substrate may contain first and second opposing surfaces, and the coating may thus be provided on the first surface of the substrate, the second surface of the substrate, or both. In one embodiment, for instance, the composite coating is provided on only the first surface. In such embodiments, the opposing second surface may be free of an additional paint layer or coating, or it may contain a different type of paint layer or coating. Of course, in other embodiments, the composite coating of the present invention may be present on both the first and second surfaces of the glass substrate. In such embodiments, the nature of the coating on each surface may be the same or different.

### A. Paint Layer

The composite coating contains at least one paint layer that overlies a surface of the glass substrate and provides a certain color thereto (e.g., white, black, blue, green, etc.). The paint layer may contain any number of different materials that can help provide a desired color to the glass article. Examples of such materials may include, for instance, glass frits, pigments, binding materials, as well as various other types of additives.

In certain embodiments, for instance, the paint layer may include a glass frit that can help adhere the layer to the substrate and/or bond to the hydrophobic layer. The glass frit may have a melting temperature of from about 400° C. to about 700° C., and in some embodiments, from about 500° C. to about 600° C. The glass frit typically contains SiO₂ in an amount from about 25 mol. % to about 55 mol. %, in some embodiments from about 30 mol. % to about 50 mol. %, and in some embodiments, from about 35 mol. % to about 45 mol. %. Other oxides may also be employed. For example, alkali metal oxides (e.g., Na₂O or K₂O) may constitute from about 5 mol. % to about 35 mol. %, in some embodiments from about 10 mol. % to about 30 mol. %, and in some embodiments, from about 15 mol. % to about 25 mol. % of the frit. Al₂O₃ may also be employed in an amount from about 1 mol. % to about 15 mol. %, in some embodiments from about 2 mol. % to about 12 mol. %, and in some embodiments, from about 5 mol. % to about 10 mol. % of the frit. In other embodiments, the composition may also contain a transition metal oxide (e.g., ZnO) as a melting point suppressant, such as in an amount from about 5 mol. % to about 40 mol. %, in some embodiments from about 10 mol. % to about 35 mol. %, and in some embodiments, from about 15 mol. % to about 30 mol. % of the frit. The glass frit may also include oxides that help impart the desired color. For example, titanium dioxide (TiO₂) may be employed to help provide a white color, such as in an amount of from about 0.1 mol. % to about 10 mol. %, in some embodiments from about 0.5 mol. % to about 8 mol. %, and in some embodiments, from about 1 mol. % to about 5 mol. % of the frit. Likewise, bismuth oxide (Bi₂O₃) may be employed in certain embodiments to help provide a black color. When employed, Bi₂O₃ may constitute from about 10 mol. % to about 50 mol. %, in some embodiments from about 25 mol. % to about 45 mol. %, and in some embodiments, from about 30 mol. % to about 40 mol. % of the frit. Of course, in addition to or in lieu of controlling the oxide content of the frit to provide the desired color, pigments may also be employed in the paint layer as is known in the art. Examples of such pigments may include, for instance, metallic pigments (e.g., aluminum flake, copper bronze flake, and metal oxide coated mica), white pigments (e.g., titanium dioxide, zinc oxide, etc.), black pigments (e.g., carbon black, iron black, titanium black, etc.), green pigments (e.g., chromium oxide pigments, copper pigments), red/orange/yellow pigments (e.g., iron oxide pigments), and so forth.

The paint layer may also contain a thermoset polymer that acts as a binding material for the layer. The thermoset polymer is generally formed from at least one crosslinkable resin, such as a (meth)acrylic resin, (meth)acrylamide resin, alkyd resin, phenolic resin, amino resin, silicone resin, epoxy resin, etc. As used herein, the term “(meth)acrylic” generally encompasses both acrylic and methacrylic resins, as well as salts and esters thereof, e.g., acrylate and methacrylate resins. Polyol resins that contain two or more hydroxyl groups are particularly suitable for use in the paint layer. Examples of such polyol resins may include, for instance, polyether polyols, polyurethane polyols, (meth)acrylic polyols, phenolic polyols, polyester polyols, and so forth. (Meth)acrylic polyols, for instance, may be copolymers of one or more alkyl esters of (meth)acrylic acid optionally in combination with one or more ethylenically unsaturated monomers. Suitable alkyl esters of (meth)acrylic acid may include methyl (meth)acrylate, ethyl (meth)acrylate, butyl (meth)acrylate, etc. Suitable ethylenically unsaturated monomers may likewise include vinyl aromatic compounds, such as styrene and vinyl toluene; nitriles, such acrylonitrile and methacrylonitrile; vinyl and vinylidene halides, such as vinyl chloride and vinylidene fluoride and vinyl esters, such as vinyl acetate. If desired, functional monomers may be employed, such as hydroxyalkyl (meth)acrylates (e.g., hydroxyethyl (meth)acrylate, hydroxypropyl (meth)acrylate, 4-hydroxybutyl (meth)acrylate, etc.).

Any of a variety of curing mechanisms may generally be employed to form the thermoset polymer. In certain embodiments, for instance, a crosslinking agent may be employed to help facilitate the formation of crosslink bonds. For example, an isocyanate crosslinking agent may be employed that can react with amine or hydroxyl groups on the crosslinkable resin (e.g., polyol resin) to provide urea or urethane crosslinked bonds. In yet another embodiment, a melamine crosslinking agent may be employed that can react with hydroxyl groups on the crosslinkable resin (e.g., polyol resin) to form the crosslink bonds. Suitable melamine crosslinking agents may include, for instance, resins obtained by addition-condensation of an amine compound (e.g., melamine, guanamine, or urea) with formaldehyde. Particularly suitable crosslinking agents are fully or partially methylolated melamine resins, such as hexamethylol melamine, pentamethylol melamine, tetramethylol melamine, etc., as well as mixtures thereof.

A variety of different techniques may generally be employed to form the paint layer. For example, in certain embodiments, one or more organic solvents may initially be combined with the crosslinkable resin, glass frit, and other optional components (e.g., pigments), sequentially or simultaneously, to form a coating formulation. Any solvent capable of dispersing or dissolving the components may be suitable, such as alcohols (e.g., ethanol or methanol); dimethylformamide, dimethyl sulfoxide, hydrocarbons (e.g., pentane, butane, heptane, hexane, toluene and xylene), ethers (e.g., diethyl ether and tetrahydrofuran), ketones and aldehydes (e.g., acetone and methyl ethyl ketone), acids (e.g., acetic acid and formic acid), and halogenated solvents (e.g., dichloromethane and carbon tetrachloride), and so forth. Although the actual concentration of solvents employed will generally depend on the components of the formulation and the substrate on which it is applied, they are nonetheless typically present in an amount from about 1 wt. % to about 40 wt. %, in some embodiments from about 5 wt. % to about 35 wt. %, and in some embodiments, from about 10 wt. % to about 30 wt. % of the formulation (prior to drying). Suitable application techniques for applying the coating formulation to the glass substrate may involve, for example, dip coating, drop coating, bar coating, slot-die coating, curtain coating, roll coating, spray coating, printing, etc. The kinematic viscosity of the formulation may be adjusted based on the particular application employed. Typically, however, the kinematic viscosity of the formulation is about 450 centistokes or less, in some embodiments from about 50 to about 400 centistokes, and in some embodiments, from about 100 to about 300 centistokes, as determined with a Zahn cup (#3), wherein the kinematic viscosity is equal to 11.7 (t-7.5), where t is the efflux time (in seconds) measured during the test. If desired, viscosity modifiers (e.g., xylene) can be added to the formulation to achieve the desired viscosity.

Once applied, the coating formulation may be heated to cure the crosslinkable resin. For example, the coating formulation may be cured at a temperature of from about 150° C. to about 350° C., in some embodiments from about 175° C. to about 325° C., and in some embodiments, from about 200° C. to about 300° C. for a period of time ranging from 30 seconds to about 50 minutes, in some embodiments from about 1 to about 40 minutes, and in some embodiments, from about 2 to about 15 minutes. Curing may occur in one or multiple steps. If desired, the coating formulation may also be optionally dried prior to curing to remove the solvent from the formulation. Such a pre-drying step may, for instance, occur at a temperature of from about 20° C. to about 150° C., in some embodiments from about 30° C. to about 125° C., and in some embodiments, from about 400° C. to about 100° C.

Generally speaking, the relative amount of the glass frit, thermoset polymer, and other optional components (e.g., pigments) in the cured paint layer may be selectively controlled to help achieve the desired properties. For example, the thermoset polymer typically constitutes from about 1 wt. % to about 20 wt. %, in some embodiments from about 2 wt. % to about 15 wt. %, and in some embodiments, from about 3 wt. % to about 11 wt. % of the paint layer. The glass frit is also typically present in the paint layer in an amount of from about 40 wt. % to about 95 wt. %, in some embodiments from about 50 wt. % to about 90 wt. %, and in some embodiments, from about 55 wt. % to about 85 wt. % of the paint layer. Likewise, when employed, pigments may also constitute from about 5 wt. % to about 35 wt. %, in some embodiments from about 10 wt. % to about 30 wt. %, and in some embodiments, from about 15 wt. % to about 25 wt. % of the paint layer. In certain embodiments, it may also be desirable to control the paint layer so that the organic material (e.g., thermoset polymer) is relatively low. Among other things, minimizing the degree of organic material can accelerate any subsequent heating steps (e.g., tempering). For example, the cured paint layer may contain organic material in an amount of from about 1 wt. % to about 11 wt. %, in some embodiments from about 2 wt. % to about 10 wt. %, and in some embodiments, from about 3 wt. % to about 8 wt. %. Because a majority of the organic material stems from the thermoset polymer, the polymer may likewise be present in an from about 1 wt. % to about 11 wt. %, in some embodiments from about 2 wt. % to about 10 wt. %, and in some embodiments, from about 3 wt. % to about 8 wt. %. In such embodiments, the combined amount of the glass frit and any optional pigments is typically from about 89 wt. % to about 99 wt. %, in some embodiments from about 90 wt. % to about 98 wt. %, and in some embodiments, from about 92 wt. % to about 97 wt. % of the paint layer. Of course, in other embodiments, it may be desirable to employ a relatively high organic material content in the paint layer, such as from about 11 wt. % to about 25 wt. %, in some embodiments from about 12 wt. % to about 20 wt. %, and in some embodiments, from about 13 wt. % to about 18 wt. %. In such embodiments, the thermoset polymer may likewise be present in an from about 11 wt. % to about 25 wt. %, in some embodiments from about 12 wt. % to about 20 wt. %, and in some embodiments, from about 13 wt. % to about 18 wt. %, and the combined amount of the glass frit and any optional pigments may be present in an from about 75 wt. % to about 89 wt. %, in some embodiments from about 80 wt. % to about 88 wt. %, and in some embodiments, from about 82 wt. % to about 87 wt. %.

### B. Hydrophobic Layer

The composite coating of the present invention also contains a hydrophobic layer that overlies the paint layer. The present inventor has discovered that the use of such a hydrophobic layer can minimize the likelihood that the paint layer will degrade and peel away from the glass substrate when contacted with an acid, which can cause an undesirable color change. Without intending to be limited by theory, for instance, it is believed that certain oxides contained within the glass frit of the paint layer (e.g., Bi₂O₃) can be hydrolyzed upon contact with an acid to generate a salt (e.g., BiO⁺) and water as byproducts. This water can attack the surface or interior structure of the paint layer, which reduces the degree to which it is adhered to the glass substrate and thus causes a change in color.

The term “hydrophobic” generally refers to a material having a relatively low surface free energy so that it is not readily wettable with water. For example, the hydrophobic material may have an advancing contact angle of about 50° or more, in some embodiments about 60° or more, and in some embodiments, from about 70° to about 90° as determined in accordance with ASTM D7334-08 (2013). Any of a variety of hydrophobic materials may generally be employed in the composite coating, such as fluoropolymers, silicone polymers, organosilane compounds (e.g., organoalkoxysilanes, organofluorosilanes, etc.), and so forth. Particularly suitable are hydrophobic materials that can be readily bonded to the paint layer and that do not substantially alter its color. In this regard, the present inventor has discovered that organoalkoxysilane compounds are particularly suitable for use in forming the hydrophobic layer. Examples of such organoalkoxysilane compounds include those having the following general formula:

R¹ₐSi(OR²)₄₋ₐ

wherein,
a is from 0 to 3, and in some embodiments, from 0 to 1;
R¹ is an alkyl, alkenyl, aryl, heteroaryl, cycloalkyl, heterocyclyl, halo, or haloalkyl; and
R² is an alkyl.

In certain embodiments, a is 0 such that that the organosilane compound is considered an organosilicate. One example of such a compound is tetraethyl orthosilicate (Si(OC₂H₅)₄). In other embodiments, a is 1 such that the organosilane compound is considered a trialkoxysilane compound. In one embodiment, for instance, R¹ in the trialkoxysilane compound may be an alkyl, aryl, or haloalkyl (e.g., fluoroalkyl) and may include a sufficient number of carbon atoms to provide the desired degree of hydrophobicity, such as from 2 to 25 carbon atoms, in some embodiments from 3 to 20 carbon atoms, and in some embodiments, from 4 to 18 carbon atoms. Several examples of such trialkoxysilane compounds include, for instance, ethyltrimethoxysilane (CH₃CH₂Si(OCH₃)₃), ethyltriethoxysilane (CH₃CH₂Si(OCH₂CH₃)₃), phenytrimethoxysilane (phenyl-(OCH₃)₃), phenytriethoxysilane (phenyl-(OCH₂CH₃)₃), hexyltrimethoxylsilane (CH₃(CH₂)₅Si(OCH₃)₃), hexyltriethoxylsilane (CH₃(CH₂)₅Si(OCH₂CH₃)₃), hexyltrimethoxylsilane (CH₃(CH₂)₅Si(OCH₃)₃), heptadecapfluoro-1,2,2-tetrahydrodecyltrimethoxysilane (CF₃(CF₂)₇(CH₂)₂Si(OCH₃)₃), 3-glycidoxyporpyltrimethoxysilane (CH₂(O)CH—CH₂O—(CH₂)₃—Si(OCH₃)₃), etc., as well as combinations thereof.

The organosilane compound may be bonded to the paint layer using techniques known in the art. For example, the organosilane compound may be subjected to a hydrolysis reaction in which one or more of the R² groups are converted into hydroxyl groups. These hydroxyl groups, in turn, react with the paint layer through a condensation reaction so that the organosilane compound becomes grafted or otherwise bonded to the paint layer. To initiate the reaction, the organosilane compound may initially be dissolved in a solvent to form a solution. Particularly suitable are organic solvents, such as hydrocarbons (e.g., benzene, toluene, and xylene); ethers (e.g., tetrahydrofuran, 1,4-dioxane, and diethyl ether); ketones (e.g., methyl ethyl ketone); halogen-based solvents (e.g., chloroform, methylene chloride, and 1,2-dichloroethane); alcohols (e.g., methanol, ethanol, isopropyl alcohol, and isobutyl alcohol); and so forth, as well as combinations of any of the foregoing. Alcohols are particularly suitable for use in the present invention. The concentration of the organic solvent within the solution may vary, but is typically employed in an amount of from about 70 wt. % to about 99 wt. %, in some embodiments from about 80 wt. % to about 98 wt. %, and in some embodiments, from about 85 wt. % to about 97 wt. % of the solution. Organosilane compounds may likewise constitute from about 1 wt. % to about 30 wt. %, in some embodiments from about 2 wt. % to about 20 wt. %, and in some embodiments, from about 3 wt. % to about 15 wt. % of the solution. Although by no means required, an acid catalyst may also be employed within the solution to help accelerate the hydrolysis and/or condensation reactions. Examples of such acid catalysts may include, for instance, acetic acid, sulfonic acid, nitric acid, hydrochloric acid, malonic acid, glutaric acid, phosphoric acid, etc., as well as combinations thereof. When employed, acid catalysts typically constitute from about 0.01 to about 2 wt. %, in some embodiments from about 0.05 to about 1 wt. %, and in some embodiments, from about 0.1 to about 0.5 wt. % of the solution.

Once formed, the solution is then coated onto the paint layer using any of a variety of known techniques, such as by dipping, drop coating, spin coating, spraying, etc. The solution is then cured at a certain temperature to bond the organosilane compound to the paint layer and form the composite coating. Although the curing temperature may vary depending on the exact material employed, it is typically within a range of from about 50° C. to about 350° C., in some embodiments from about 75° C. to about 325° C., and in some embodiments, from about 100° C. to about 300° C. The time period for curing may likewise vary, but is typically from about 1 to about 100 minutes, in some embodiments from about 2 to about 60 minutes, and in some embodiments, from about 4 to about 50 minutes. Curing generally results in the creation of a silane network in which oxygen atoms link adjacent silicon atoms and also covalently bond silicon atoms to the paint layer. At the interface, the silane reacts with itself and also with the paint layer, crosslinking and interlocking mechanically with the layer.

If desired, the glass article may also be subjected to an additional heat treatment (e.g., tempering, heat bending, etc.) to further improve the properties of the article. The heat treatment may, for instance, occur at a temperature of from about 500° C. to about 800° C., and in some embodiments, from about 550° C. to about 750° C. Although this heat treatment can occur after the composite coating is formed, it is often desirable to conduct the heat treatment prior to forming the hydrophobic layer (e.g., after the paint layer is formed) to minimize the extent to which any of the hydrophobic materials might degrade during heating.

The present invention may be better understood with reference to the following examples.

### Test Methods

Water Repellency: The ability of a surface to repel water can be characterized by the “advancing contact angle”, which may be determined in accordance with ASTM D7334-08 (2013).

Color Change: The color change of a surface may be determined using a value known as “ΔE”, which is well understood in the art and can be determined in accordance with ASTM 2244-16. ΔE may, for instance, correspond to the CIE LAB Scale L*, a*, b*, wherein L* is (CIE 1976) lightness units; a* is (CIE 1976) red-green units; b* is (CIE 1976) yellow-blue units. For this scale, the distance between L*₀a*₀b*₀ and L*₁a*₁b*₁ is: ΔE=[(Δ*)²+(Δa*)²+(Δb*)²]^{1/2}, where ΔL*=L*₁−L*₀; Δa*=a*₁−a*₀; Δb*=b*₁−b*₀; the subscript “₀” represents the initial color of the article and the subscript “₁” represents the color of the article after a change in conditions (e.g., CASS testing); and the numbers employed (e.g., a*, b*, L*) are those calculated by the aforesaid (CIE LAB 1976) L*, a*, b* coordinate technique. When the coating-side ΔE values are measured, then coating side a*, b* and L* values are used. Likewise, when glass side ΔE values are measured, glass side a*, b* and L* values are used.

Corrosion Resistance: The ability of a surface to resist corrosion can be determined in accordance with ASTM B368-09 (2014), which is known as the Copper-Accelerated Acetic Acid-Salt Spray (Fog) Testing (“CASS” Test). During this test, samples are subjected to a salt fog containing laden copper ions and then examined for color change after 120 hours of exposure using the method described above.

Solvent Resistance: The ability of a surface to resist solvents can be determined in accordance with ASTM D5402-15 using a MEK (methyl ethyl ketone) solvent. More particularly, the surface is rubbed with a cloth 300 times using a cloth containing the MEK solvent. The water contact angle may be measured after one or more of the rub cycles (e.g., after 100, 200, or 300 rubs) to test the chemical resistance of the surface.

Acid/Base Resistance: The ability of a surface to resist acid/bases can be determined by soaking a sample in either a 2 wt. % HCl or 4 wt. % NaOH solution for a time period of about 180 minutes. The water contact angle may be measured at various points during the test (e.g., after 30, 60, or 180 minutes) to test the resistance of the surface.

Abrasion Resistance: The ability of a surface to resist abrasion can be determined as follows. A sample having a size of 2 inches by 3 inches is placed in a deionized water bath and thereafter contacted with a brush (DQB Industries) to scratch the coated surface. The water contact angle may be measured after various cycles or number of brushes (300, 600, 1,000, and 1,500 cycles) to test the abrasion resistance.

### Control 1

A black coating solution was obtained from Fenzi and applied to one surface of a glass plate (6 mm in thickness, size of 3 inches by 3 inches) using a slot die coating process. The coating was cured in an oven at a temperature of 300° C. for 20 minutes, and the coated glass plate was thereafter subjected to a heat treatment at a temperature of 680° C. for 10 minutes.

### EXAMPLE 1

A coated glass substrate was formed as described in Control 1 and thereafter applied with a hydrophobic layer to form a composite coating. More particularly, a solution was initially formed by adding 10 grams of hexyltrimethoxysilane to 49 milliliters of isopropyl alcohol. Acetic acid (0.2 milliliters) was added to the solution, and it was thereafter stirred for 24 hours. 1 milliliter of the solution was then dropped onto the center of the paint-coated side of the glass substrate. The substrate was then spun (“spin coating”) to a maximum speed of 1,000 revolutions per minute (ramp rate of 225 revolutions per minute) for a period of 30 seconds to uniformly coat the solution onto the surface. The coating was cured in an oven at a temperature of 250° C. for 20 minutes.

Once formed, samples of the coated glass substrates of Control 1 and Example 1 were subjected to CASS chamber testing and then each side (coating and glass sides) was tested for color change. The results are set forth below in Table 1.

TABLE 1
Color Changes Before and After
CASS Testing (6 mm)

| | Average ΔE | Average ΔE |
|---|---|---|
| | of Coating Side | of Glass Side |
| Control 1 | 6.3 | 0.90 |
| (6 samples) | | |
| Example 1 | 0.3 | 1.0 |
| (2 samples) | | |

As indicated, the samples of Example 1, which contained the composite coating of the present invention, had a significantly lower color change after CASS testing than the samples of Control 1.

### Control 2

A black coating solution was obtained from Fenzi and applied to one surface of a glass plate (3 mm in thickness, size of 3 inches by 3 inches) using a slot die coating process. The coating was cured in an oven at a temperature of 300° C. for 20 minutes, and the coated glass plate was thereafter subjected to a heat treatment at a temperature of 680° C. for 5 minutes.

### EXAMPLE 2

A coated glass substrate was formed as described in Control 2 and thereafter applied with a hydrophobic layer in the same manner as described in Example 1. Samples of the coated glass substrates of Control 2 and Example 2 were subjected to CASS chamber testing and then each side (coating and glass sides) was tested for color change. The results are set forth below in Table 2.

TABLE 2
Color Changes Before and After
CASS Testing (3 mm)

| | Average ΔE | Average ΔE |
|---|---|---|
| | of Coating | of Glass |
| | Side | Side |
| Control 2 | 4.0 | 0.5 |
| (3 samples) | | |
| Example 2 | 1.0 | 0.6 |
| (3 samples) | | |

As indicated, the samples of Example 2, which contained the composite coating of the present invention, had a significantly lower color change after CASS testing than the samples of Control 2. The samples of Example 2 were also tested for abrasion resistance, solvent resistance, and acid/base resistance using the tests described above. The water contact angle was measured at various points during the tests. The results are set forth below in Tables 3-5.

TABLE 3
Water Contact Angle After
Brush Cycle Testing

| Brush Cycle | Water Contact |
|---|---|
| Number | Angle (°) |
| 0 | 79 |
| 300 | 68 |
| 600 | 70 |
| 1,000 | 65 |
| 1,500 | 63 |

TABLE 4
Water Contact Angle After
MEK Solvent Rub Testing

| MEK Rub | Water Contact |
|---|---|
| Cycle Number | Angle (°) |
| 0 | 93 |
| 100 | 85 |
| 200 | 83 |
| 300 | 76 |

TABLE 5
Water Contact Angle
After Acid/Base Testing

| | Water | Water |
|---|---|---|
| | Contact | Contact |
| | Angle (°)- | Angle (°)- |
| Minutes | Acid Test | Base Test |
| 0 | 93 | 83 |
| 30 | 69 | 57 |
| 60 | 69 | 62 |
| 180 | 75 | 67 |

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A glass article comprising a composite coating that is provided on a surface of a glass substrate, wherein the composite coating comprises a paint layer that overlies the surface of the glass substrate and a hydrophobic layer that overlies the paint layer, wherein the coating exhibits a ΔE value of about 2 or less after being exposed to a copper-accelerated acetic acid-salt spray (“CASS”) in accordance with ASTM B368-09 (2014).

2. The glass article of claim 1, wherein the paint layer contains a glass frit and a thermoset polymer that is formed from a crosslinkable resin, and the hydrophobic layer contains an organosilane compound that is bonded to the paint layer.

3. A glass article comprising a glass substrate and a composite coating that is provided on a surface of a glass substrate, wherein the composite coating comprises a paint layer that overlies the surface of the glass substrate and a hydrophobic layer that overlies the paint layer, wherein the paint layer contains a glass frit and a thermoset polymer, and wherein the hydrophobic layer contains an organosilane compound that is bonded to the paint layer.

4. The glass article of claim 3, wherein the coating exhibits a ΔE value of about 2 or less after being exposed to a copper-accelerated acetic acid-salt spray (“CASS”) in accordance with ASTM B368-09 (2014).

5. The glass article of claim 1, wherein the glass substrate has a thickness of from about 0.1 to about 15 millimeters.

6. The glass article of claim 1, wherein the glass substrate has a first surface and an opposing second surface, wherein the composite coating is provided on the first surface.

7. The glass article of claim 2, wherein the glass frit contains bismuth oxide.

8. The glass article of claim 2, wherein the crosslinkable resin includes a (meth)acrylic resin, (meth)acrylamide resin, alkyd resin, phenolic resin, amino resin, silicone resin, epoxy resin, or a combination thereof.

9. The glass article of claim 2, wherein the crosslinkable resin includes a polyol resin.

10. The glass article of claim 9, wherein the polyol resin is a copolymer of one or more alkyl esters of (meth)acrylic acid optionally in combination with one or more ethylenically unsaturated monomers.

11. The glass article of claim 10, wherein the polyol resin is crosslinked with a melamine crosslinking agent.

12. The glass article of claim 1, wherein the paint layer has a black color.

13. The glass article of claim 1, wherein the paint layer contains one or more pigments.

14. The glass article of claim 1, wherein the paint layer contains organic material in an amount of from about 1 wt. % to about 11 wt. %.

15. The glass article of claim 1, wherein the paint layer contains organic material in an amount of from about 11 wt. % to about 25 wt. %.

16. The glass article of claim 2, wherein the organosilane compound is an organoalkoxysilane compound having the following general formula:
R¹ₐSi(OR²)₄₋ₐ
wherein,
a is from 0 to 3;
R¹ is an alkyl, alkenyl, aryl, heteroaryl, cycloalkyl, heterocyclyl, halo, or haloalkyl; and
R² is an alkyl.

17. The glass article of claim 16, wherein a is 1.

18. The glass article of claim 17, wherein R¹ is an alkyl, aryl, or haloalkyl.

19. The glass article of claim 16, wherein the organoalkoxysilane compound includes ethyltrimethoxysilane, ethyltriethoxysilane, phenytrimethoxysilane, phenytriethoxysilane, hexyltrimethoxylsilane, hexyltriethoxylsilane, hexyltrimethoxylsilane, heptadecapfluoro-1,2,2-tetrahydrodecyltrimethoxysilane, 3-glycidoxyporpyltrimethoxysilane, or a combination thereof.

20. The glass article of claim 1, wherein the coating exhibits an advancing contact angle of about 50° or more as determined in accordance with ASTM D7334-08 (2013).

21. The glass article of claim 20, wherein the coating exhibits an advancing contact angle of about 50° or more after being rubbed with methyl ethyl ketone for 300 cycles in accordance with ASTM D5402-15.

22. The glass article of claim 20, wherein the coating exhibits an advancing contact angle of about 50° or more after being soaked in a 2 wt. % HCl aqueous solution for 180 minutes.

23. The glass article of claim 20, wherein the coating exhibits an advancing contact angle of about 50° or more after being soaked in a 4 wt. % NaOH aqueous solution for 180 minutes.

24. A method for forming a glass article, the method comprising:
applying a coating formulation to a surface of a glass substrate, wherein the coating formulation contains a crosslinkable resin and a glass frit;
curing the coating formulation to form a paint layer;
applying a solution of a hydrophobic material to the paint layer; and
curing the hydrophobic material to form a hydrophobic layer that is bonded to the paint layer.

25. The method of claim 24, wherein the paint layer and glass substrate are subjected to a heat treatment prior to bonding of the hydrophobic layer to the paint layer, wherein the heat treatment is conducted at a temperature of from about 500° C. to about 800° C.

26. The method of claim 24, wherein the hydrophobic material includes an organosilane compound.

27. The method of claim 26, wherein the organosilane compound is subjected to a hydrolysis reaction and then reacted with the paint layer through a condensation reaction.

28. The method of claim 24, wherein the solution contains an organic solvent and optionally an acid catalyst.

29. The method of claim 24, wherein the solution is cured at a temperature of from about 50° C. to about 350° C.
